(19) United States
(12) Patent Application Publication
(10) Pub. No.: US 2012/0279407 A1
(43) Pub. Date: Nov. 8, 2012

(54) Paper coater apparatus and process

(75) Inventors: Marc El Khoury, Beirut (LB); Elie Njeim, Beirut (LB)

(73) Assignee: PHOENIX MACHINERY

(21) Appl. No.: 13/137,651

(22) Filed: Aug. 31, 2011

Related U.S. Application Data
(60) Provisional application No. 61/457,653, filed on May 6, 2011.

(51) Int. Cl. B41F 27/06

(52) U.S. Cl. 101/376

(57) ABSTRACT

A gravure coating apparatus for applying coating material to a first side of a traveling continuous web to produce a smooth uniform coated surface on said web first side, having means for continuously advancing the web over a transfer applicator roller with a gravure roll having an engraved surface pattern engaging a resilient transfer roller positioned for applying a coating to the entire width of the first side of the continuous web while the continuous web is formed as an arc over the transfer applicator roll. A transfer applicator roll and a kiss roller assembly mounted adjacent the transfer applicator roll apply coating material to the web. The kiss roll assembly comprises a mounting plate, two rollers mounted on the mounting plate and drive means to reciprocate the kiss roller assembly toward and away from the transfer applicator roll holding the web against the transfer applicator roll.

### RELATED APPLICATIONS

The present application is related to and claims priority from U.S. Provisional Patent Application No. 61/457,653 filed May 6, 2011.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to an apparatus and process for chemically impregnating paper and other non-woven webs, and is more particularly concerned with an apparatus which applies a polyethylene terephthalate, PET coating on an engraved roller which, then delivers the PET coating to a resilient transfer roller which engages and coats the paperweb in a preselected pattern to uniformly coat an impregnated web.

### BACKGROUND OF THE INVENTION

Manufacturers of products made of a non-woven web, such as paper and paperboard, have long known the desirability of coating a paper web with a PET coating to enhance desired features in the product.

Corrugated board as used in the present application generally refers to a composite laminated structure comprising two paper linerboard sheets bonded to a paper corrugated or fluted core material. In the context of the present description a corrugated material will mean at least one liner sheet bonded to at least one fluted layer. Single faced corrugated board refers to the structure where there are single sheets of linerboard bonded to the tips of a single fluted core layer. There are various other combinations which can be fabricated to form various well know products such as double wall board, triple wall board, and the like.

The typical process for forming corrugated materials is well known and typically the single wall corrugated board will be formed on an in-line corrugator where large rolls of linerboard paper and a large roll of the medium paper (the starting raw material for forming the corrugated core layer) will be positioned at the upstream end of the corrugator. The process normally has the medium passing through a set of corrugating rolls and thereafter being bonded to the first liner as it travels in a downstream direction. A suitable adhesive is utilized to attach the flute tips on one side to the inside surface of the first liner. Thereafter, at a downstream location the other liner material is laminated to the other flute tips with a suitable adhesive to form the combined board. Thereafter the combined board travels into a heating and cooling section to allow the adhesive to fully cure and bond the liners to the fluted medium. Immediately thereafter slitter-scorer and cutoff devices function to produce individual flat sheets of slit and scored blanks for converting into containers.

A number of methods have been used to apply coatings to paper such as squeezing, rolling, cascading, spraying, or doctoring various coatings onto the linerboard, paper, carton stock, or corrugated medium surface, after which the coating is cooled or set. Such methods can generally be classified into:

1. Wax cascaders: in which paraffin waxes and wax based compounds are traditionally applied to semi-formed boxes that are placed on conveyor mounted wire frames and conveyed under a waterfall or cascade of hot molten product, after which the boxes continue through a cooling tunnel supplied with refrigerated air as a means of solidifying the coating.

2. Wax curtain coaters in which paraffin waxes and wax based compounds are traditionally applied to semi-formed boxes on a die cutting machine that first cuts the form for the box from a corrugated sheet, folds the cut form into a collapsed flat form, and then places it on a conveyor which carries the box under a curtain of hot molten product that issues from a side-to-side slit at the end of the melted product delivery pipe, after which the boxes may continue through a cooling tunnel supplied with refrigerated air as a means of solidifying the coating, and may or may not be flipped or inverted to expose the uncoated side to a second curtain coater or to feed it through the original curtain coater on a second pass.

3. Wax impregnators in which: linerboard or folding carton sheet is fed from a roll that may be mounted at the rear of a corrugating machine and then travels forward through a bath of hot melted product which is normally equipped with opposing squeezing or dressing rolls that force the melted product into the linerboard sheet and remove the excess, which falls back into the bath. Once a linerboard sheet is impregnated, it then moves forward on the corrugator and may be incorporated in corrugated board as one of the three or more sheets that form standard corrugated board. In some instances the impregnated linerboard may be used as one of the outside liners or it may be used as the fluted medium sheet sandwiched in the middle of the corrugated sheet, and in other instances, two or more impregnators may be employed to apply melted product to two or several of the linerboard sheets that compose the corrugated board.

4. Wax spray coaters: in which paraffin waxes and wax based compounds are traditionally applied to semi-formed boxes on a die cutting machine that first cuts the form for the box from a corrugated sheet, folds it into a collapsed flat form, and then places it on a conveyor which carries the box under one or a bank of several spray heads that are heated to temperatures sufficient to assure that the molten product remains fluid until it has contacted and semi-penetrated the box linerboard substrate, after which the boxes continue through a cooling tunnel supplied with refrigerated air as a means of solidifying the coating, and may or may not be flipped or inverted to present the uncoated side to a second spray coater or to feed it through the original spray coater on a second pass.

Water repellent packaging that utilizes petroleum based liquid polymers or polymer film laminates (including polyethylene or similar film laminates such as polyolefin, polyester, polyvinyl alcohol, polyvinyl acetate, polystyrene, polypropylene, and the like) have been proven to be recyclable; however, all require the installation of specialized repulping machinery that separates the pulp fibers from the laminated films and/or is far more expensive in terms of operating costs and/or recycled pulp fiber yields. The action of separating the fiber from the film damages some fibers causing them to be selected out of the recycled pulp and/or presented for reuse, and the separated waste film carries some of the fibers out of the repulpate when its adherence is not interrupted by the repulping process.

The previously noted coating processes are disclosed in U.S. Pat. No. 6,846,573 issued Jan. 25, 2005.

U.S. Pat. No. 5,858,551 issued Jan. 12, 1999 discusses coating paper and paperboard and is directed toward various PET compositions having a highly modified polyester backbone and other groupings. Polyethylene terephthalate (PET) such as virgin PET, recycled PET, or post consumer PET can be used as a paper coating composition. One coating composition disclosed in this reference has a terephthalate polymer and 10 to 60% by weight of a hydrophobic compound selected from the group consisting of C6-C24 straight chain or branched fatty acid of triglycerides. See also U.S. Pat. No. 5,252,615 issued Oct. 12, 1993 which teaches a coating composition derived from alcoholysis of polyethylene terephthalate (PET).

The general concept of selective application of chemical to a web is disclosed in U.S. Pat. No. 4,617,223 issued Oct. 14, 1986. While this reference discusses many advantages of selective application, no specific apparatus is disclosed in detail. The method disclosed utilizes a printing or screening apparatus such as a flexographic printing process, gravure printing or stenciling.

U.S. Pat. No. 5,332,458 issued Jul. 26, 1994 discusses a corrugated paperboard strength enhancing process includes at least one resin application station located within the confines of the corrugator at a position where it is operable to apply a preselected amount of a strength enhancing resin to at least one side of the medium after it has been fluted. At least one liner is adhered to the set of opposed flute tips. Thereafter the combined board with the resin compound on selected transverse portions of the fluted medium is allowed to cure, under selected temperature and moisture conditions and without the application of pressure that would crush the fluted medium.

The present invention solves current recycling problems for water repellant packaging in that the PET coated, hydrogenated triglyceride corrugated paper produced by the present apparatus is recyclable without the need for specialized repulping machinery. The longitudinal uniformity of the coating is achieved with a 3% or less coat weight difference.

### SUMMARY OF THE INVENTION

The present invention provides an apparatus for applying a gravure coating of PET to a transfer roll which then applies the PET to a hydrogenated triglyceride impregnated web of paper in a uniform thickness coating over the top and bottom surface of the web of paper without producing longitudinal wrinkles. The apparatus not only produces a smooth coating on a thin web, but it also allows precise control of thickness of the coating layer on the web.

In one aspect of the invention, coating material is transferred from a gravure roll to a resilient transfer roll which applies its coating to the surface of a moving continuous paper liner web. A doctor blade applied coating material to the gravure roll surface immediately before the coating material is applied to a resilient transfer roll. The coating material is applied by the resilient transfer roll to the web surface so that no matter how thin the web, the coating can be applied evenly on the web coated surface. A kiss assembly having opposed rollers on each end engages the web and holds the same against the resilient transfer roll to receive the coating from the resilient transfer roll.

Accordingly, it is an object of the present invention to provide a coating apparatus used in conjunction with an impregnation apparatus, or impregnator, which is durable in structure, and efficient in operation.

Still another object of the present invention is to provide a corrugated paper coater apparatus which can selectively control quantities of coating material to the web.

Yet another object of the present invention is to provide an impregnator in conjunction with the coater apparatus which selectively impregnates a web of paper in a continuous manner.

Another object of the present invention is to provide a coating apparatus which coats a web of paper at relatively high speeds in conjunction with the corrugation process.

Still another object of the present invention is to provide an impregnator used in conjunction with the coating apparatus which impregnates a web of paper at relatively high speeds.

Yet another object of the invention allows longitudinal uniformity of the coating applied to the web with a 3% or less coat weight difference.

Another object of the invention is to provide a coating apparatus which can be used on corrugators without the requirement of additional operation skills.

Another object of the invention allows a special kiss assembly allow for a splice to pass thru the coating rollers without any web brake.

Another object of the invention allows the ease of allowing the web to engage the coaters without the need for a re-thread of the web being coated.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a schematic side elevation of the inventive paper treating and coating assembly;

FIG. 2 is an enlarged schematic side elevation of the coating rollers of the invention;

FIG. 3 is a partial side elevation of the schematic shown in FIG. 2; and

FIG. 4 is a side perspective view of the apparatus shown in FIGS. 3 and 4.

### DETAILED DESCRIPTION OF THE INVENTION

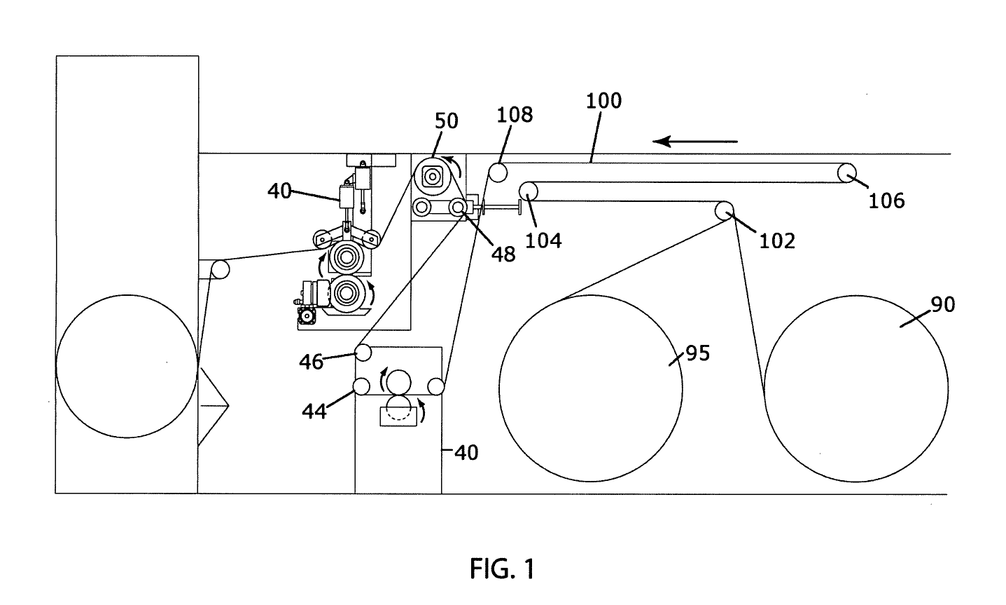

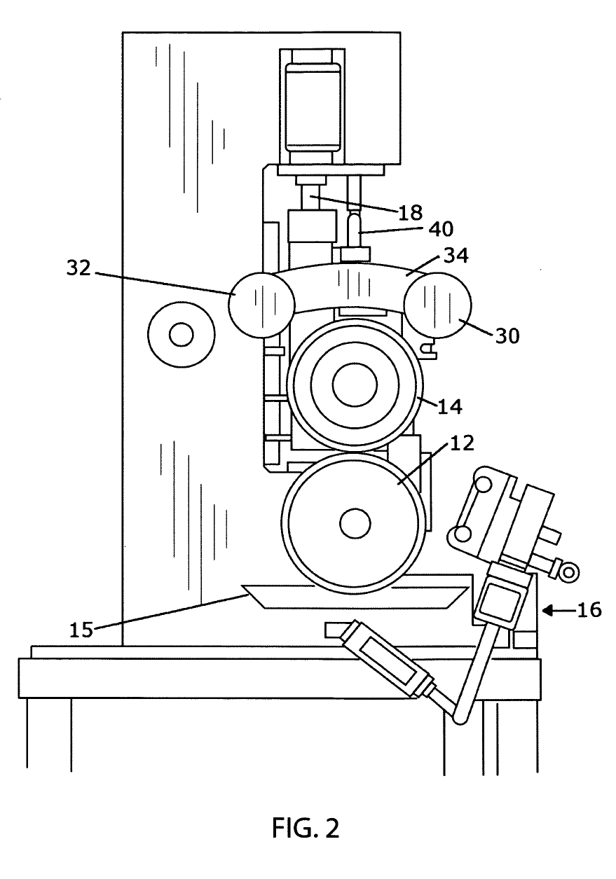

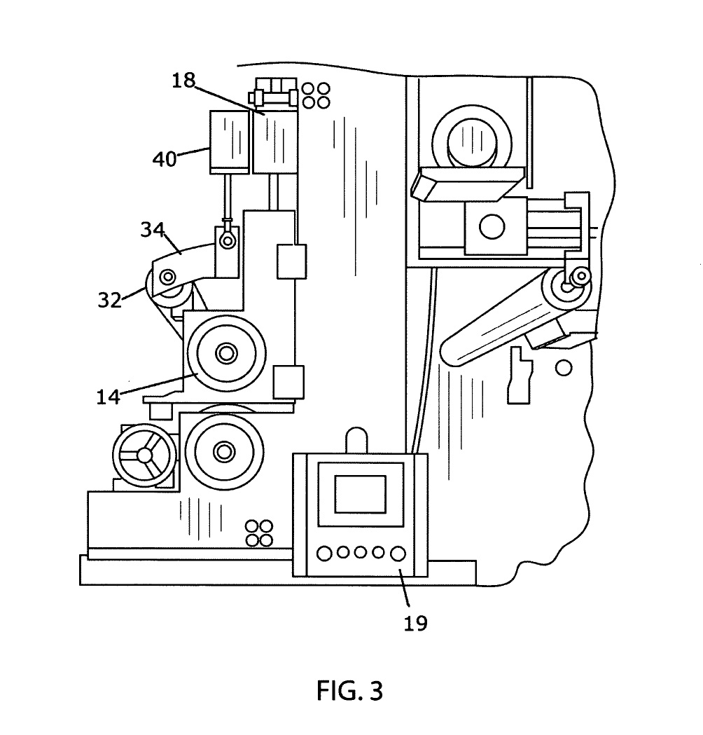

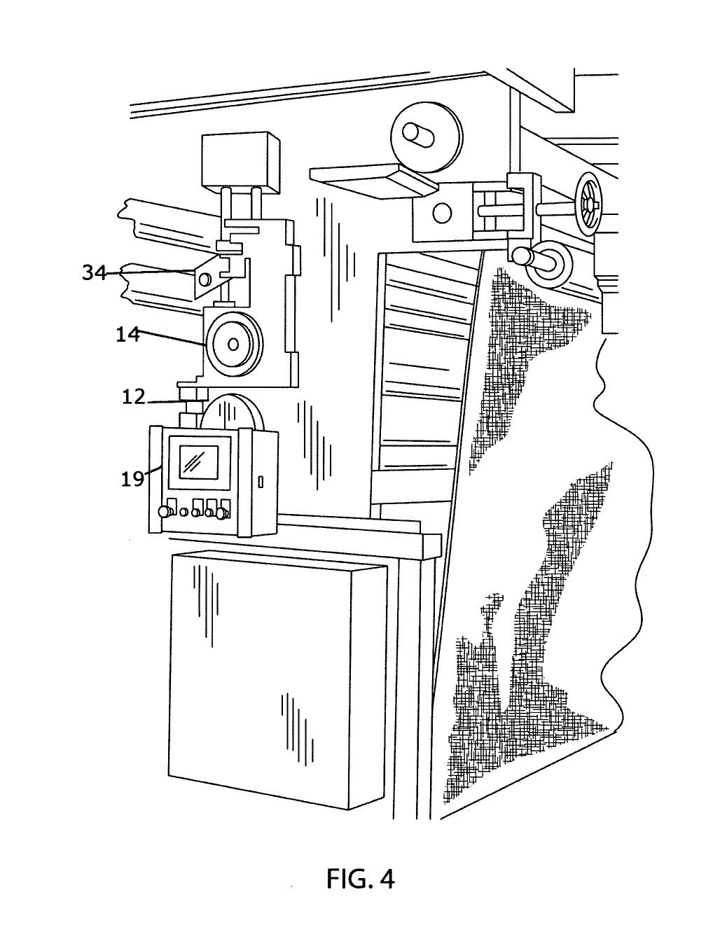

The preferred embodiment and best mode of the invention is shown in FIGS. 1 through 4.

In the invention, an offset gravure coater assembly 11 is used in combination with a corrugated paper forming apparatus. Two coater assemblies 11 are envisioned as being used for coating the finished corrugated paper board, each constructed with a gravure roll 12, a rubber applicator transfer roll 14, a closed doctor chamber assembly 16, and a reciprocating kiss roller assembly 28 for the impression mechanism. Each coater assembly 11 has the ability to run in Direct Gravure, Reverse Gravure, and Offset Gravure forward and reverse wipe. Both the gravure roll 12 and applicator transfer roll 14 are driven and have adjustable speed ratios so as to be able to adjust coat weights. Two separate 20HP motors (not shown) are used to drive the respective gravure roll 12 and applicator transfer roll 14. Controls to run the motors and thus the respective relative speed of the two rollers are found on control panel 19.

Identical top and bottom coater assemblies 11 are used in the operation of the corrugated coating process and the following description applies to each assembly. A closed doctor chamber 18 supplies coating material preferably polyethylene terephthalate (PET) to the gravure roll 12. The gravure roll 12 is laser engraved and ceramic coated and is used to transfer the coating material to the rubber transfer roller 14. The gravure roll 12 measures 12″ nominal diameter, with the base is constructed of carbon steel with stainless steel journals and heads, double can design for chilled water and is ceramic plated and engraved according to customer specifications. The rubber transfer roll 14 transfers the metered coating material from the gravure roller 12 to the incoming paper web 100. The rubber transfer roller 14 measures 11″ nominal diameter, and the base has a 10″ nominal diameter in carbon steel with stainless steel journals and heads. The rubber covering the base core is preferably 65A durometer rubber with a one inch thickness. A catch pan 15 is located under the gravure roller 12 to collected excess coating material which falls from the doctor assembly 16 and transfer roll 14.

A kiss roller assembly 28 is constructed with two idler rollers 30 and 32 rotatably mounted to a side plate 34. The rollers 30 and 32 are pneumatically actuated to engage the web 100 on opposite sides of the transfer roller 14 as seen in FIG. 1 by a reciprocating pneumatic drive assembly 40. The offset gravure coater has the capability to change coat weights applied to the web 100 by varying the roll speeds. The kiss roller assembly 28 helps to smooth the coating, minimizing the appearance of the engraved cell pattern on the substrate. The kiss rollers 30 and 32 are mounted on adjustable slides to vary the web wrap, which also will change the coat weight lay down. With the present kiss roll assembly 28, a lap splice will pass without damage or the necessity to change out the rollers.

The rubber covered applicator roll 14 is mounted on pneumatically loaded slides 18 to apply a nip load on the gravure roll 12 required to pull the coating out of the engraved cells on the roll surface. The cylinders are sized to apply the impression pressure needed if the coater is configured to run in direct or reverse gravure mode.

The coating assemblies are designed to be highly versatile and can be operated in several configurations. The units are set up to run as offset gravure reverse wipe, giving the smoothest coating application with the most lay down control. Direct gravure (bottom liner only). In direct gravure a nip impression of 70 PLI is possible. This will coat most paper/liner board of 15 point or less. Reverse gravure. Offset gravure forward wipe (bottom liner only). Offset gravure reverse wipe.

In the offset mode, the coat weight of the PET is adjustable by varying the gravure roll 12 and the applicator roll 14 roll speeds. The coat weight lay down is controlled by the engraved volume of the gravure roll. Reverse gravure will help smooth the coating and minimize the cell pattern appearance.

In operation, on the bottom coater assembly 11, the incoming web of top liner sheet 90 is matched with a bottom liner sheet 95 with combined web 100 being carried by idler rollers 102, 104, 106 and 108 to an impregnator 40 which impregnates the sheets web 100 with a hydrogenated triglyceride, preferably tallow. After leaving the impregnator 40, the impregnated web 100 will wrap over a web driven, steam roll 50. The web 100 is then wrapped under an operator platform and over idler rolls 44 and 46 then onto the first roll 30 of the 2-roll kiss assembly. Tensioning of the web 100 is maintained by idler, tension roll 48. All idler rolls measure 6″ nominal diameter and are chrome plated carbon steel. The rollers 30 and 32 of kiss assembly 28 loads the web 100 against the rubber transfer roll 14 where the coating is applied to the bottom sheet 95. The gravure roll 12 is in a fixed position over a stainless steel catch pan 15 providing easy change out. The rubber covered applicator roll 14 is mounted on pneumatically loaded slides 18 to apply the nip load required to pull the coating out of the engraved surface of the gravure roller 12. Both cylinders (transfer roll 14 and gravure roll 12) are sized to apply the impression pressure needed if the coater is configured to run in direct or reverse gravure mode. A Graymills drum pump supplies coating to the doctor assembly applicator 16. The enclosed doctor applicator 16 is provided with pneumatic blade clamp loading for tool-less blade changes. The doctor applicator body is a hard anodized aluminum with stainless steel hardware. The two roll kiss assembly 28 arrangement helps to smooth the coating and minimize the appearance of the engraved cell pattern on the web. The kiss assembly 28 is adjustable to vary the web wrap which will also change the coat weight lay down. With the kiss roll assembly 28, a lap splice will pass without damage.

After leaving the kiss assembly 28, the web 100 will pass over an out-feed idler 60. On the top coater assembly, the incoming web is reverse coated in the same manner as previously set forth. The web 100 wraps around an idler roll (not shown) then on to the first roll 20 of the 2-roll kiss assembly. The kiss assembly for the top coater 11 is the same as the bottom coater 11. The liner sheets 90 and 95 are then glued to the fluted medium which has been impregnated with the hydrogenated triglyceride used to impregnate the top and bottom liners. The liners are glued onto the fluted medium as is standard and well known in the industry to form a corrugated paper board which is then dried by standard heating means.

The advantage of using the present invention is that a 3% coat weight variation in the transversal direction can be achieved using the noted coaters. Longitudinal uniformity of the coating is also achieved with a 3% coat weight difference. Film layer formation of the coating material is found on the top and bottom of the cardboard sheet.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What we claim is:

1. Gravure coating apparatus for applying coating material to a first side of a traveling continuous web to produce a smooth uniform coated surface on said web first side, comprising:
a. means for continuously advancing said web in extended generally linear disposition;
b. a gravure roll having engraved surface pattern engaging a resilient transfer roller, said resilient transfer applicator roller being of a width sufficient to contact the entire width of said continuous web, said transfer applicator roll being positioned for applying a coating to the entire width of the first side of said continuous web while said continuous web is formed as an arc over said transfer applicator roll;
c. means for providing said coating material to said gravure roll; and
d. means for controlling the amount of coating material on said gravure roll prior to transfer of said coating material from said gravure roll to said transfer roll surface.

2. Gravure coating apparatus as claimed in claim 1 further comprising means for rotating said gravure roll and said transfer applicator roll in opposite directions so that said transfer applicator roll surface and said web move in opposite directions.

3. Gravure coating apparatus as claimed in claim 1 wherein said means for controlling the amount of coating material on the said gravure roll is a closed doctor chamber mechanism.

4. Gravure coating apparatus as claimed in claim 1 wherein said transfer roll has a rubber outer surface.

5. Gravure coating apparatus as claimed in claim 4 wherein said rubber outer surface has 65A durometer.

6. Gravure coating apparatus as claimed in claim 1 wherein said coating material is PET.

7. Gravure coating apparatus as claimed in claim 1 including a web impregnation assembly positioned upstream from said coating apparatus.

8. Gravure coating apparatus as claimed in claim 1 including a kiss roller assembly mounted adjacent said transfer applicator roll for engagement with said continuous web, said kiss roll assembly comprising a mounting plate, two rollers mounted on said mounting plate and means to reciprocate said kiss roller assembly toward and away from said transfer applicator roll.

9. Gravure coating apparatus as claimed in claim 8 wherein said rollers are mounted on said mounting plate on opposite ends of said mounting plate.

10. Gravure coating apparatus for applying coating material to a first side of a traveling continuous web to produce a smooth uniform coated surface on said web first side, comprising:
a. means for continuously advancing said web over a transfer applicator roller;
b. a gravure roll defining an engraved surface pattern engaging a resilient transfer roller, said resilient transfer applicator roller being of a width sufficient to contact the entire width of said continuous web, said transfer applicator roll being positioned for applying a coating to the entire width of the first side of said continuous web while said continuous web is formed as an arc over said transfer applicator roll;
c. means for providing said coating material to said gravure roll;
d. means for controlling the amount of coating material on said gravure roll prior to transfer of said coating material from said gravure roll to said transfer roll surface, said transfer applicator roll; and
e. a kiss roller assembly mounted adjacent said transfer applicator roll, said kiss roll assembly comprising a mounting plate, two rollers mounted on said mounting plate and drive means to reciprocate said kiss roller assembly toward and away from said transfer applicator roll holding said web against said transfer applicator roll.

11. Gravure coating apparatus as claimed in claim 10 wherein said rollers are mounted on opposite ends of said mounting plate.

12. Gravure coating apparatus as claimed in claim 10 wherein said kiss roller assembly drive means is a pneumatic drive is a cylinder housing a shaft mounted to said mounting plate to reciprocate said plate towards and away from said transfer applicator roll.

13. Gravure coating apparatus as claimed in claim 10 wherein said coating material is PET which is applied to said web with less than 3% coat variation in the transverse direction.

14. Gravure coating apparatus for applying coating material to a first side of a traveling continuous web to produce a smooth uniform coated surface on said web first side, comprising:
a. means for continuously advancing said web in extended generally linear disposition;
b. an impregnator apparatus, said impregnator apparatus apply a preselected amount of hydrogenated triglyceride to a corrugated paperboard to impregnate said corrugated paperboard;
c. a gravure roll having an engraved surface pattern positioned for applying said coating to a resilient transfer roll, said coated transfer roll applying said coating to the first side of said continuous web while said continuous web is engaging said transfer roll;
d. means for providing coating material to said gravure roll from a doctor blade assembly;
e. means for controlling the amount of coating material on said gravure roll and said transfer roll prior to transfer of said coating material from said gravure roll to said transfer roll; and
f. means for adjustably varying the speed of rotation of said gravure roll to produce a relative velocity difference between said web and said transfer roll, the rotational velocity of said gravure roll at the surface of said transfer roll being faster than the running velocity of said web to control the smoothness of coating applied to said web.

15. Gravure coating apparatus as claimed in claim 14 wherein said coating material is PET.

16. Gravure coating apparatus as claimed in claim 14 wherein said a kiss roller assembly mounted adjacent said transfer applicator roll for engagement with said continuous web, said kiss roll assembly comprising a mounting plate, two rollers mounted on said mounting plate and means to reciprocate said kiss roller assembly toward and away from said transfer applicator roll.

17. Gravure coating apparatus as claimed in claim 14 wherein said web impregnation assembly positioned upstream from said coating apparatus.

18. Gravure coating apparatus as claimed in claim 16 wherein said kiss roller assembly drive means is a pneumatic drive is a cylinder housing a shaft mounted to said mounting plate to reciprocate said plate towards and away from said transfer applicator roll.
